(19) United States
(12) Patent Application Publication
(10) Pub. No.: US 2009/0037305 A1
(43) Pub. Date: Feb. 5, 2009

(54) System and Method for Monitoring Tax Information

(75) Inventors: Joachim Sander, Mannheim (DE); Stefan Scheid, Hanhofen (DE); Barbara Leibssle, Monchengladbach (DE); Isabel Molina Jimenez, Eppingen (DE); David E. Nelson, Troutman, NC (US)

Correspondence Address: FISH & RICHARDSON, P.C., PO BOX 1022, MINNEAPOLIS, MN, 55440-1022, US

(73) Assignee: SAP AG, Walldorf (DE)

(21) Appl. No.: 11/833,185

(22) Filed: Aug. 2, 2007

(51) Int. Cl. G06F 19/00

(52) U.S. Cl. 705/31; 235/379

(57) ABSTRACT

This disclosure provides various embodiments of software for monitoring tax information in a business application. In one aspect, the software collects a set of tax information associated with at least one taxed entity from a plurality of logically disparate sub-modules, each sub-module associated with a business application. The software presents at least a portion of the collected set of tax information at a centralized reporting interface to a first client authorized by the particular taxed entity, wherein presenting at least a portion of the set of tax information comprises displaying one or more of the following: tax information related to one or more tax returns associated with the particular taxed entity; tax information related to one or more tax registers associated with the particular taxed entity; or tax information related to one or more tax payments associated with the particular taxed entity.

### TECHNICAL FIELD

This disclosure relates to data processing and, more particularly, to presenting or otherwise facilitating monitoring of tax information at a user interface.

### BACKGROUND

Taxes are administered and collected by taxing authorities in many jurisdictions throughout various regions and countries of the world. Generally, the occurrence of a financial transaction, such as a sale of goods or services, may trigger tax liabilities according to one or more tax types of a specific region. In other instances, taxes may be assessed based on payrolls, earnings, or income. Regardless of the basis of the tax, in most jurisdictions paying taxes is a legal requirement for businesses and individuals. In order to accurately pay taxes, entities attempt to organize and monitor their tax liabilities. For example, monitoring taxes can be necessary to track payments, check the accuracy of calculated liabilities, and help ensure successful processing of the various taxes owed by the entity. However, monitoring tax liability is currently difficult—or at a minimum, time-consuming—even when taxes are due to only one taxing authority. Further, when an entity does business in more than one jurisdiction, or when doing business in a particular location subjects an entity to multiple levels of taxes (i.e., federal, state, and/or local), organizing and monitoring tax liabilities becomes ever more complicated and expensive.

### SUMMARY

This disclosure provides various embodiments of software for monitoring tax information in a business application. In one aspect, the software collects a set of tax information associated with at least one taxed entity from a plurality of logically disparate sub-modules, each sub-module associated with a business application. The software presents at least a portion of the collected set of tax information at a centralized reporting interface to a first client authorized by the particular taxed entity, wherein presenting at least a portion of the set of tax information comprises displaying one or more of the following: tax information related to one or more tax returns associated with the particular taxed entity, tax information related to one or more tax registers associated with the particular taxed entity, or tax information related to one or more tax payments associated with the particular taxed entity.

While generally described as software, some or all of these aspects may be further included in respective systems or other devices for executing, implementing, or otherwise monitoring tax information in a business application. The details of these and other aspects and implementations of the disclosure are set forth in the accompanying drawings and the description below. Other features, objects, and advantages of the present disclosure will be apparent from the description and drawings, and from the claims.

### DESCRIPTION OF DRAWINGS

FIG. 1 illustrates a software environment that monitors the tax liabilities of an entity according to a particular implementation of the present disclosure;

FIG. 2 is a flowchart illustrating an example of the steps for monitoring the tax liabilities of an entity within the illustrated environment of FIG. 1;

FIG. 3A illustrates one implementation of the general data tab of the tax return view provided to the client of the illustrated environment of FIG. 1;

FIG. 3B illustrates one implementation of the payment information tab of the tax return view provided to the client of the illustrated environment of FIG. 1;

FIG. 3C illustrates one implementation of the notes tab of the tax return view provided to the client of the illustrated environment of FIG. 1;

FIG. 4 illustrates one implementation of the tax register view provided to the client of the illustrated environment of FIG. 1;

FIG. 5A illustrates one implementation of the general data tab of the tax payment view provided to the client of the illustrated environment of FIG. 1;

FIG. 5B illustrates one implementation of the tax return data tab of the tax payment view provided to the client of the illustrated environment of FIG. 1; and

FIG. 6 is a diagram of a generic business object in a particular implementation of FIG. 1.

### DETAILED DESCRIPTION

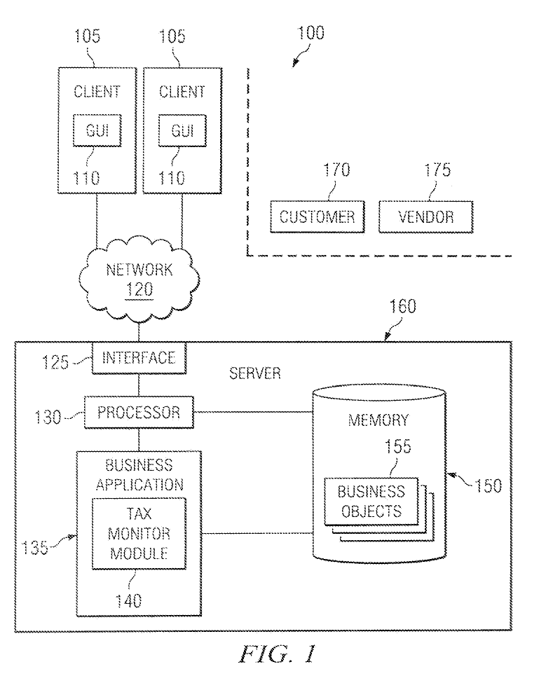

FIG. 1 illustrates at least a portion of an enterprise or data processing environment 100 implementing or facilitating the monitoring of tax liabilities for one or more entities via a business application 135 and tax monitor module 140. In accordance with particular implementations, illustrated environment 100 utilizes the business application 135 and tax monitor module 140 (running within a server 160 in communication with one or more business objects 155) to provide up-to-date information regarding the tax liabilities of one or more entities associated with the one or more clients 105. The proffered solution allows for clients 105, on behalf of, or authorized by, one or more of the taxed entities to monitor, at one location, the tax returns, the tax register, and the tax payments associated with a particular one of the entities. In addition to monitoring an entity's tax information, clients 105 may be able to initiate audits or further investigation of certain tax information. In short, the tax monitor module 140 may generate a centralized tax monitor interface 300 where users may review one or more entities' tax data, making transparent the tax status of various documents (e.g., invoices, credit notes, and so forth) and transactions according to the entities' tax arrangement. To view the tax data, the user may choose to display elements within the tax monitor interface 300 and request information by free data selection (e.g., declaration type, declaration status, tax authority, etc.). Multiple selections may be possible for the selection fields (e.g., to select more than one entity, declaration type, and tax authority in a certain period). By providing the relevant tax information and tools for tax-related functions at a central location, the present disclosure allows entities (and their agents) to accurately and consistently monitor the entities' tax obligations and actions, allowing for better bookkeeping and budgeting regarding the taxes for which the entities may be liable.

Turning to the example implementation of FIG. 1, environment 100 includes, or is communicably coupled, with the server 160, one or more clients 105, and a network 120. Additionally, environment 100 may include one or more customers 170 and/or vendors 175. The server 160 may include a memory 150, as well as one or more processors 130, and comprise an electronic computing device operable to receive, transmit, process, store, or manage data associated with the environment 100. Generally, this disclosure provides merely one example of computers that may be used with the disclosure. As used in this document, the term “computer” is intended to encompass any suitable processing device. For example, the environment 100 may be implemented using computers other than servers, as well as a server pool. Indeed, the server 160 may be adapted to execute any operating system including Linux, UNIX, Windows, or any other suitable operating system. According to one implementation, the server 160 may also include or be communicably coupled with a web server and/or a mail server.

Memory 150 may include any memory or database module and may take the form of volatile or non-volatile memory including, without limitation, magnetic media, optical media, random access memory (RAM), read-only memory (ROM), removable media, or any other suitable local or remote memory component. For example, memory 150 may store classes, frameworks, applications, backup data, business objects, jobs, or other information that includes any parameters, variables, algorithms, instructions, rules, constraints, or references thereto. The memory 150 may also include any other appropriate data, such as virtual private network (VPN) applications, firmware logs and policies, firewall policies, a security or access log, print or other reporting files, HTML files or templates, and others.

Specifically, illustrated memory 150 includes one or more business objects 155 that may be utilized and accessed by the business application 135. While illustrated within memory 150 of FIG. 1, one or more business objects 155 may be located outside the memory 150 and/or the server 160 in some implementations. The one or more sets of business objects 155 may be those business objects or modules used, among other things, to store relevant tax information regarding the taxed entity, to calculate the tax liabilities of the entity based on various inputs such as sales, income, and/or employment, or to process and record the tax payments of an entity to certain taxing authorities. By providing the business application 135 with access to the one or more business objects 155, the business application 135 may organize the information into a comprehensible and centralized interface such that clients 105 and other authorized users may review and use the compilation of tax information in normal accounting and business operations. The one or more business objects 155 may include particular business objects 155 that contain and/or process information related to taxes levied upon or applicable to a particular taxed entity.

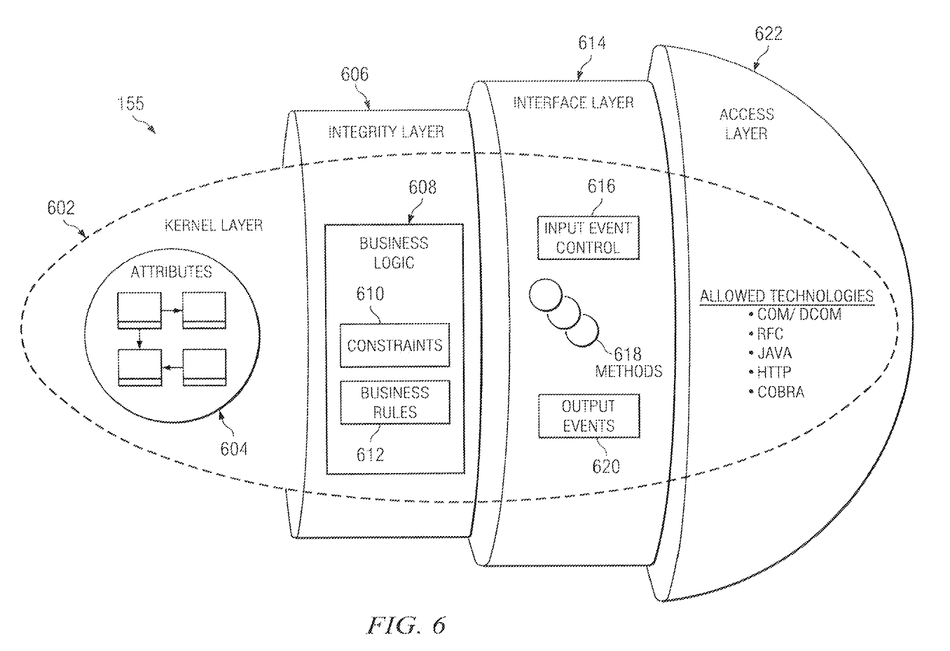

FIG. 6 illustrates the structure of a generic business object 155 in environment 100. In general, the overall structure of the business object model ensures the consistency of the interfaces that are derived from the business object model. The derivation helps ensure that the same business-related subject matter or concept can be represented and structured in the same way in various interfaces. The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

A business object is a capsule with an internal hierarchical structure, behavior offered by its operations, and integrity constraints. Business objects are semantically disjointed, i.e., the same business information is represented once. A business object may be defined such that it contains multiple layers, such as in the example business object 155 of FIG. 6. The example business object 155 contains four layers: the kernel layer 602, the integrity layer 606, the interface layer 614, and the access layer 622. The innermost layer of the example business object is the kernel layer 602. The kernel layer 602 represents the business object's 155 inherent data, containing various attributes of the defined business object. The second layer represents the integrity layer 606. In the example business object 155, the integrity layer 606 contains the business logic 608 of the object. Such logic may include business rules 612 for consistent embedding in the environment 100 and the constraints 610 regarding the values and domains that apply to the business object 155. Business logic 608 may comprise statements that define or constrain some aspect of the business, such that they are intended to assert business structure or to control or influence the behavior of the business entity. It may pertain to the facts recorded on data and constraints on changes to that data. In effect, business logic 608 may determine what data may, or may not, be recorded in business object 155. The third layer, the interface layer 614, may supply the valid options for accessing the business object 155 and describe the implementation, structure, and interface of the business object to the outside world. To do so, the interface layer 614 may contain methods 618, input event controls 616, and output events 620. The fourth and outermost layer of the business object 155 in FIG. 6 is the access layer 622. The access layer 622 defines the technologies that may be used for external access to the business object's 155 data. Some examples of allowed technologies may include COM/DCOM (Component Object Model/Distributed Component Object Model), CORBA (Common Object Request Broker Architecture), RFC (Remote Function Call), Hypertext Transfer Protocol (HTTP) and Java, among others. Additionally, business objects 155 of this embodiment may implement standard object-oriented technologies such as encapsulation, inheritance, and/or polymorphism.

Returning to FIG. 1, illustrated server 160 also includes the processor 130. The processor 130 executes instructions and manipulates data to perform the operations of the associated server 160 such as, for example, a central processing unit (CPU), a blade, an application specific integrated circuit (ASIC), or a field-programmable gate array (FPGA). Although described as a single processor in the server 160, multiple processors 130 may be used according to particular needs, and references to processor 130 are meant to include multiple processors where applicable. In this particular illustration, processor 130 executes the business application 135.

At a high level, business application 135 is any application, program, module, process, or other software that may execute, change, delete, generate, or otherwise manage business information according to the present disclosure. In certain cases, environment 100 may implement a composite application 135. For example, portions of the composite application may be implemented as Enterprise Java Beans (EJBs) or design-time components, and may have the ability to generate run-time implementations in different platforms, such as J2EE (Java 2 Platform, Enterprise Edition), ABAP (Advanced Business Application Programming) objects, or Microsoft's .NET. Further, while illustrated as internal to server 160, one or more processes associated with business application 135 may be stored, referenced, or executed remotely. For example, a portion of application 135 may be a web service that is remotely called, while another portion of application 135 may be an interface object bundled for processing at remote client 105. Moreover, application 135 may be a child or sub-module of another software module or enterprise application (not illustrated) without departing from the scope of this disclosure. Additionally, in some instances application 135 may be a hosted solution that allows multiple parties in different portions of the process to perform the respective processing. For example, client 105 may access business application 135 on server 160, or even as a hosted application located over network 120, without departing from the scope of this disclosure. In another example, portions of business application 135 may be used by an authorized user working directly at server 160, as well as remotely at client 105. In yet another example, business application 135 may be hosted by a third party entity for use by a remote client 105 authorized by the taxpaying entity. Regardless of the particular implementation, “software” may include software, firmware, wired or programmed hardware, or any combination thereof as appropriate. Indeed, each software component may be fully or partially written or described in any appropriate computer language including C, C++, Java, Visual Basic, assembler, Perl, any suitable version of 4GL, as well as others.

More specifically, business application 135 may be a composite application, or an application built on other applications, that includes an object access layer (OAL) and a service layer. In this example, business application 135 may execute or provide a number of application services such as customer relationship management (CRM) systems, human resources management (HRM) systems, financial management (FM) systems, project management (PM) systems, knowledge management (KM) systems, and electronic file and mail systems. Such an OAL is operable to exchange data with a plurality of enterprise-based systems and to present the data to a composite application through a uniform interface. The example service layer is operable to provide services to the composite application. These layers may help composite application 135 to orchestrate a business process in synchronization with other existing processes (e.g., native processes of enterprise-based systems) and leverage existing investments in the IT platform. Further, composite application 135 may run on a heterogeneous IT platform. In doing so, composite application 135 may be cross-functional in that it may drive business processes across different applications, technologies, and organizations. Accordingly, composite application 135 may drive end-to-end business processes across heterogeneous systems or sub-systems. Application 135 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes the composite application 135, it may instead be a standalone or (relatively) simple software program. Regardless, application 135 may also perform processing automatically, which may indicate that the appropriate processing is substantially performed by at least one component of environment 100. It should be understood that this disclosure further contemplates any suitable administrator or other user interaction with application 135 or other components of environment 100 without departing from its original scope.

For example, the illustrated business application 135 is associated with the tax monitor module 140, which may be embedded within the business application 135 as shown in FIG. 1, or instead may be communicably coupled to the business application 135 within server 160. In still other instances, the tax monitor module 140 may be a separate application located remote from the server 160, yet tightly integrated with the business application 135 through connections via the network 120. The tax monitor module 140 may be an agent or module running on server 160 that retrieves and processes tax information from the one or more business objects 155. In some implementations, the tax monitor module 140 may be a separate, standalone application similar to the business application 135 described above. In other implementations, the tax monitor module 140 provides the functionality disclosed in the present application—specifically, it may collect tax information from one or more sources (e.g., one or more business objects 155) and generate an interactive interface provided to authorized users at one or more clients 105 for reviewing and auditing tax-related information associated with a particular entity. In addition to retrieving and displaying the retrieved information, the tax monitor module 140 may allow for authorized users to select particular tax returns, tax registers, or tax payments, as well as specific individual elements therein, that should be audited or reviewed by the particular business object 155 which supplied the selected tax information.

As described, the tax monitor module 140 (and/or the business application 135) may supply the generated interactive interface to one or more authorized users at one or more clients 105 via the network 120. Information supplied at the one or more clients 105 by the authorized users may then be transmitted to the tax monitor module 140 (and/or business application 135). If the information supplied requires the retrieval of additional data from, or the transmission of commands to, the particular business object 155 responsible for the particular tax information, then the internal connections of server 160 may be used to perform those actions on the particular business objects 155. In instances where one or more of the business objects 155 are located outside of the server 160, the data retrieval and command transmissions may be performed utilizing the network 120. In some instances, the tax monitor module 140 may include the programming necessary to communicate with the one or more business objects 155, while in other instances, the tax monitor module 140 may rely on the business application's 135 programming. Indeed, in certain implementations the tax monitor module's 140 functionality may be limited to organizing the tax information received from one or more business objects 155 into a single presentation format. In those implementations, the business application 135 may perform the functions of retrieving data from one or more of the business objects 155 relating to a particular entity's tax information, displaying the organized tax information to the user interface, processing commands received during user interactions, and communicating with one or more business objects 155 based upon the instructions and/or commands supplied by users. Thus, the tax monitor module 140 may be wholly, or in part, comprised of additional programming and/or instructions written into the internal code of the business application 135.

Further, the server 160 may include an interface 125 for communicating with other computer systems in a client-server or other distributed environment, such as clients 105 or other servers connected to the network 120. Generally, interface 125 comprises logic encoded in software and/or hardware in a suitable combination and operable to communicate with the network 120. More specifically, interface 120 may comprise software supporting one or more communication protocols associated with communications such that the network 120 or hardware is operable to communicate physical signals.

The network 120 facilitates wireless or wireline communication between the server 160 and any other local or remote computer, such as the clients 105. Indeed, while illustrated as one network, the network 120 may be a discontinuous network without departing from the scope of this disclosure, so long as at least a portion of the network 120 may facilitate communications between senders and recipients. The network 120 may be all or a portion of an enterprise or secured network. In some instances, a portion of the network 120 may be a VPN merely between the server 160 and the client 105 across a wireline or wireless link. Such an example wireless link may be via 802.11a, 802.11b, 802.11g, 802.20, WiMax, or other types of wireless links. In other words, the network 120 encompasses any internal or external network, networks, sub-network, or combination thereof operable to facilitate communications between various computing components in the system. The network 120 may communicate, for example, Internet Protocol (IP) packets, Frame Relay frames, Asynchronous Transfer Mode (ATM) cells, voice, video, data, and other suitable information between network addresses. The network 120 may include one or more local area networks (LANs), radio access networks (RANs), metropolitan area networks (MANs), wide area networks (WANs), all or a portion of the Internet, and/or any other communication system or systems at one or more locations. In certain implementations, the network 120 may be a secure network associated with the enterprise and certain local or remote clients 105.

The client 105 may be any computing device operable to connect or communicate with server 160 or the network 120 using a wireless or wireline connection. At a high level, each client 105 includes at least the GUI 110, and comprises an electronic computing device operable to receive, transmit, process, and/or store any appropriate data associated with the business application 135 and the tax monitor module 140. It will be understood that there may be any number of clients 105 communicably coupled to the server 160 at any point in time. For example, the environment 100 may include two local clients 105, as illustrated in FIG. 1, as well as other clients external to the illustrated portion of the network 120 (not illustrated). Further, “the client 105,” “accountant,” and “user” (sometimes referred to as “authorized user”) may be used interchangeably as appropriate without departing from the scope of this disclosure. For example, the user may access a first instance of the business application 135 on a first client 105, while an accountant may use a second instance of the business application 135 on a second client 105. Moreover, for ease of illustration, each client 105 is described in terms of being used by one user. This disclosure, however, contemplates that more than one user may use one computer, or that one user may use multiple computers. As used in this disclosure, the client 105 is intended to encompass a personal computer, touch screen terminal, workstation, network computer, kiosk, wireless data port, smart phone, personal data assistant (PDA), one or more processors within these or other devices, or any other suitable processing device. For example, the client 105 may comprise a computer that includes an input device, such as a keypad, touch screen, mouse, or other device that can accept information, and an output device that conveys information associated with the operation of the server 160 or the clients 105, including digital data, visual information, or the GUI 110. Both the input device and the output device may include fixed or removable storage media, such as a magnetic computer disk, CD-ROM, or other suitable media to both receive input from and provide output to users of the clients 105 through the display, namely, the GUI 110.

GUI 110 comprises a graphical user interface operable to allow the user of the client 105 to interface with at least a portion of environment 100 for any suitable purposes such as to allow the client 105 to interact with the business application 135 and, if the user is authorized by a particular entity, provide an interface for displaying and reviewing the tax information associated with that particular entity. Generally, the GUI 110 provides the client 105 with an efficient and user-friendly presentation of data provided by or communicated within the system. In particular, the GUI 110 may provide users of the business application 135 with access to data stored within memory 150. The GUI 110 may comprise a plurality of user interface (UI) elements such as interactive fields, pull-down lists, and buttons operable at the client 105. These UI elements may be associated with tax-related functions provided by the tax monitor module 140 and the business application 135, such as reviewing and/or auditing particular aspects of an entity's tax information (e.g., tax returns or payments). In one implementation, the GUI 110 may provide a centralized and interactive display capable of presenting tax-related information retrieved from one or more of the business objects 155 and organized by the tax monitor module 140. In some instances, the GUI 110 may provide a view displaying the different tax reports and tax returns created by one or more of the business objects 155 as directed by the business application 135. In other instances, the GUI 110 may provide an interactive display presenting the elements, transactions, and values used to calculate the different tax reports and returns. These items may include sales receipts, reported revenues, or employment information, among others. In still other implementations, the GUI 110 may provide a view displaying the details of one or more payments made to one or more tax authorities in satisfaction of the tax liabilities determined by the tax reports and returns calculated by the business application 135 and one or more business objects 155. Moreover, it should be understood that the term graphical user interface may be used in the singular or in the plural to describe one or more graphical user interfaces and each of the displays of a particular graphical user interface. Therefore, the GUI 110 contemplates any graphical user interface, such as a generic web browser, touch screen, or command line interface (CLI) that processes information in environment 100 and efficiently presents the results to the user. The server 160 can accept data from the clients 105 via the web browser (e.g., Microsoft Internet Explorer or Mozilla Firefox) and return the appropriate HTML or XML responses using the network 120.

Environment 100 may further include one or more customers 170 and/or vendors 175. The customer 170 may be a client or other entity, whether non-profit or for-profit, doing business with a particular taxed entity. For instance, the customer 170 may be a purchaser, lessor, or other party to a transaction with the taxed entity. The vendor 175, on the other hand, may be an entity or business from which the taxed entity purchases or leases goods or services. Based on the transactions between the taxed entity and either the customer 170 or the vendor 175, tax liabilities may arise for the taxed entity. One or more business objects 155 may process or otherwise control these transactions such that the transactions are recorded and the resulting tax liabilities are calculated. The tax liabilities, along with the details regarding the originating transactions, may make up all or a part of the tax information monitored by the tax monitor module 140.

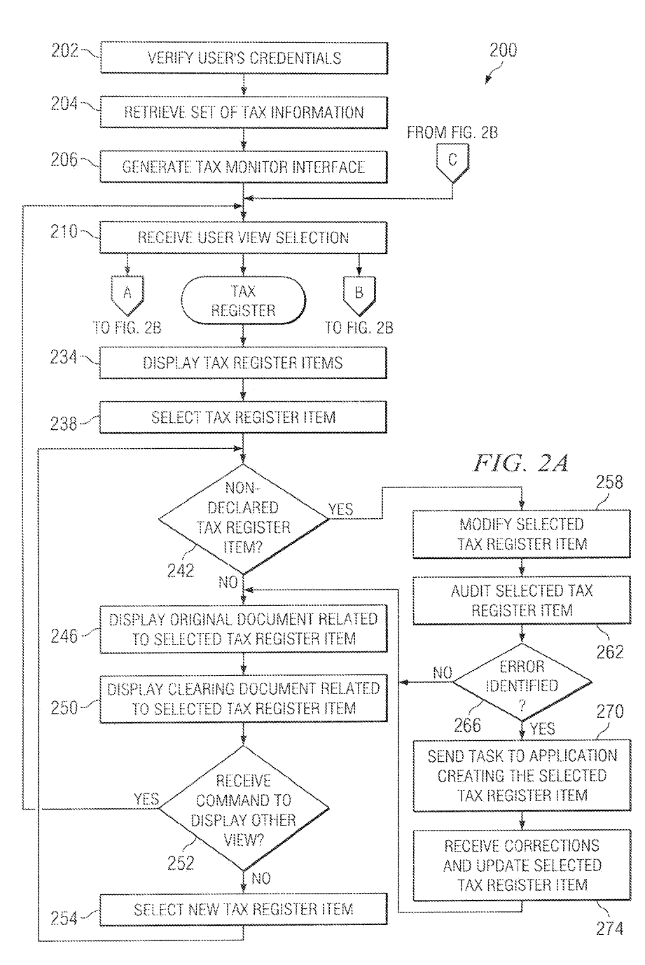

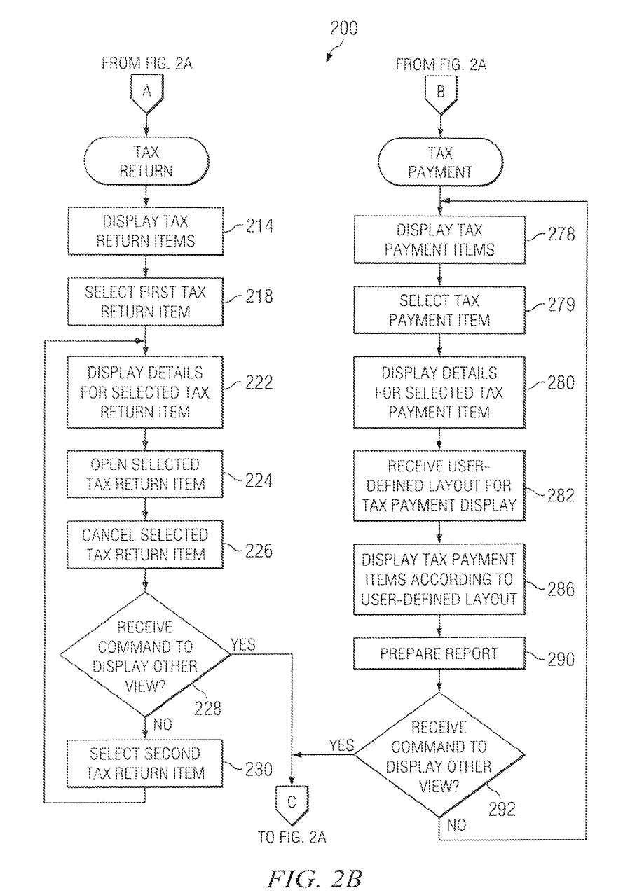

FIG. 2 provides a flowchart illustrating an example process 200 for monitoring tax information related to one or more taxed entities, as illustrated in FIG. 1. While the flowcharts illustrate one particular embodiment of environment 100 and tax monitor 140, this disclosure contemplates using any appropriate combination and arrangement of logical elements to implement some or all of the described functionality. At a high level, process 200 describes one particular implementation for facilitating the monitoring of tax liabilities for one or more entities at a client 105.

At step 202, the tax monitor module 140 may receive and verify a set of user credentials identifying the authorization level of a specific user at one of the clients 105. Because an entity's tax information may include confidential and/or sensitive information, users at remote clients 105 may be required to use entity- or user-specific login information prior to accessing the tax monitor interface. By adding this layer of security, only users authorized by the taxed entities may view the tax information using the tax monitor module 140 and the business application 135. In some instances, remote clients 105 may be located at a particular taxed entity such that access to the client 105 indicates that the user is authorized to access the tax information. Other methods of user authentication and security may be used by process 200 to protect confidential and sensitive information. Additionally, in other instances process 200 may not include verifying a user's credentials prior to accessing the tax information. In still other instances, a user may be authorized to view more than one entity's tax information. For instance, an authorized user for a corporation may also be an authorized user for one or more of that corporation's subsidiaries. Thus, a single set of credentials may provide access to the tax information for a plurality of taxed entities. The credentials themselves may be stored in the memory 150, or at any other location such that the credentials provided by the user may be verified prior to providing access to one or more entities' tax information.

Once the user's credentials are verified, at step 204 the tax monitor module 140 may retrieve the set of tax information specific to the entities for which the user is authorized. In some instances, the tax monitor module 140 may receive a request for a specific entity's tax information from the authorized user, while in other instances, the tax monitor module 140 may retrieve the information associated with one or more of the entities for which the user is authorized. As described in relation to FIG. 1, the tax monitor module 140 may include the programming necessary to retrieve the information from the one or more business objects 155 storing the tax information, or the tax monitor module 140 may employ the business application's 135 functionality to retrieve the data. Regardless of the retrieval method used, the tax information is retrieved for further use by the tax monitor module 140.

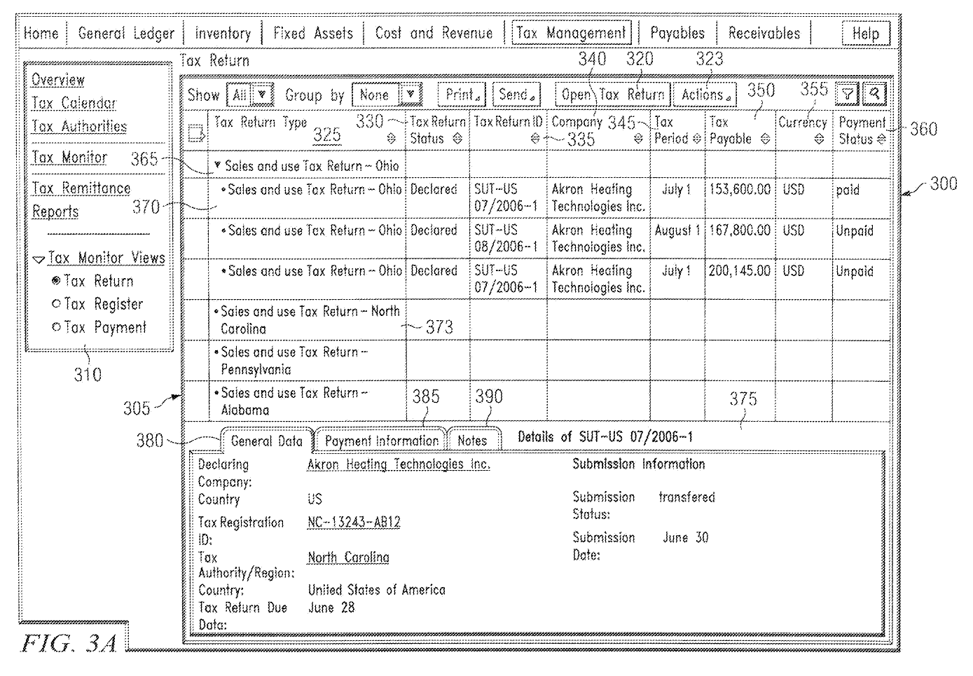

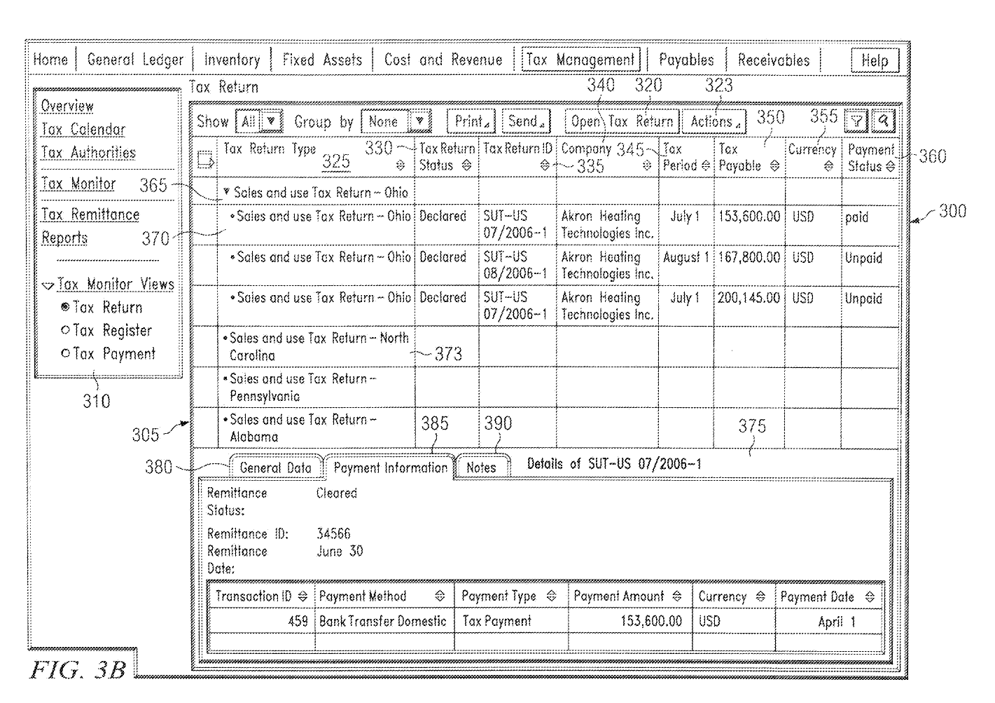

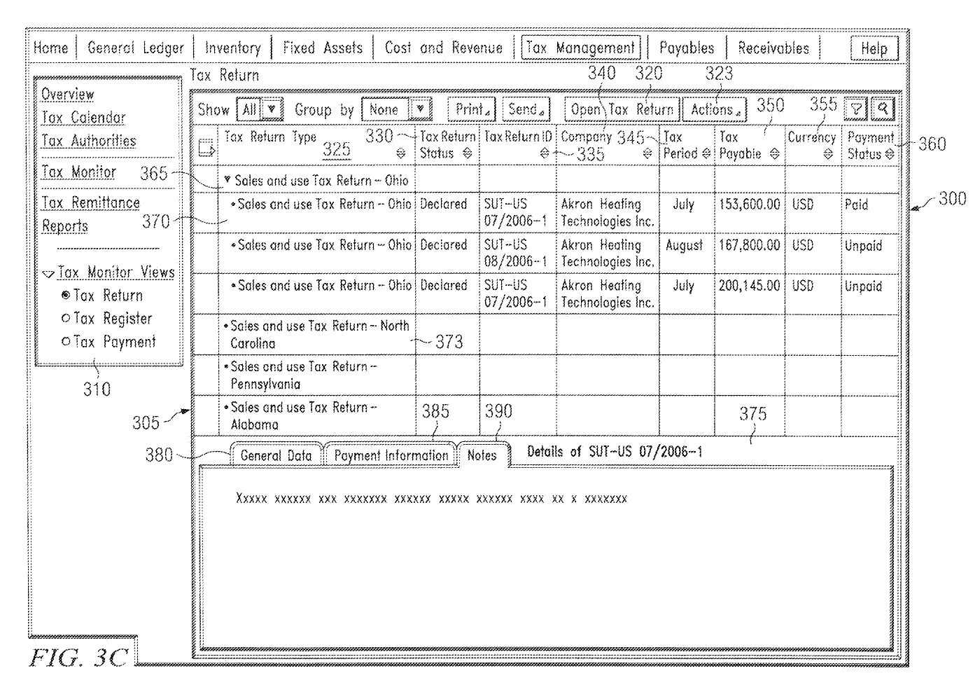

Once the tax information for the one or more entities authorized under the user's credentials is retrieved, the tax monitor module 140 may generate a tax monitor interface 300 (illustrated in FIGS. 3A-5B) at the GUI 110 of the client 105 at step 206. Thus, the GUI 110 may be populated with an interactive set of data regarding one or more entities' tax information. In the current example, the tax monitor module's 140 functionality may be provided as a new option among one or more previously available tax-related options. In other instances, however, the tax monitor interface 300 may be a standalone interface unrelated to existing interfaces. In some implementations, the process 200 may provide three separate views within the tax monitor interface 300, each displaying a different subset of the retrieved tax information. In that example, the three views of the tax monitor interface 300 may include a tax return view 305, a tax register view 405, and a tax payments view 505. After the tax monitor module 140 has generated the tax monitor interface 300, a view selection (illustrated by UI element 310 in FIGS. 3A-5B) may be received from the authorized user, such that one of the available views is displayed. In some instances, the tax return view 305 may be the default view shown initially following generation of the tax monitor interface 300. In still other instances, the user may set a preferred initial view to be displayed upon startup of the tax monitor interface 300.

The tax return view 305 permits the user to review already created tax return items relevant to all tax declaration types (e.g., declarations which are being worked on currently, created declarations and their processing status in the system, cancelled declarations, corrected declarations, and prepayments). At step 214, the tax monitor module 140 displays at least a portion of the tax information related to one or more tax return items associated with one or more of the user's authorized entities. In some instances, the tax monitor module 140 may parse through the retrieved set of tax information to determine which data relates to one or more tax returns. In other instances, the retrieved tax information, when initially provided, may be separated into categories according to whether the information relates to one or more tax returns, tax registers, or tax payments. The portion of the tax information related to the one or more tax return items may be organized in a predetermined layout by the tax monitor module 140. In some instances, the predetermined layout may be a hierarchical or quasi-hierarchical layout. As illustrated in FIG. 3A, the tax return information may initially be organized and sorted according to the tax return type field 325. Additionally, the information may be sorted by one or more of the fields illustrated in FIG. 3A: the tax return status field 330, the tax return ID field 335, the company field 340, the tax period field 345, the tax payable field 350, the currency field 355, or the payment status field 360. In some instances, the fields presented in the tax return view 305 may include, but are not limited to, the following: tax declaration type, tax declaration status, tax declaration period, company, tax declaration ID, tax declaration total amount (in declaration currency), carry forward amount, declaration difference total amount, tax payment status, tax payment total amount, tax payment date, tax authority, tax authority country code, sent date, confirmation date, system administrative data, approval status, or submission status (status of data transfer).

Top-level element 365 illustrates an expanded set of tax information that is grouped by Sales and Use Tax Returns for Ohio. In some implementations, the first top-level element may be expanded when the interface is initially displayed. In other implementations, some, all, or none of the top-level elements may be initially expanded. Top-level element 373 shows a grouping of tax information that is in a collapsed state. By activating the top-level element through a mouse-click or other user action, the tax return items grouped in that category may be displayed. In some instances, one or more entities may be associated with a tax group, wherein the tax group is represented by a representative entity. When an entity is associated with a tax group, the tax monitor module 140 may provide information identifying the tax group and the representative entity.

When displaying the set of tax return items, the tax monitor module 140 may determine which tax return items have had prepayments applied by the taxed entity. In instances where a prepayment has been made, the prepayments may be displayed at the end of the each declaration type. Additionally, the declaration status field may have a value of “Prepayment.” In other instances, the tax monitor module 140 may determine whether the amount of taxes paid is different from the calculated tax amount. In cases where the values differ, the difference may be displayed to the user. In cases where the actual and calculated amounts are the same, the tax monitor interface 300 may indicate that with a zero value, a note indicating payment in full, or another type of indication. In implementations where one or more tax return items are valued in different currencies, the tax monitor module 140 may provide tax amount totals in each currency.

At step 218, one of the tax return items may be selected by the user. In FIG. 3A, the second-level element 370 with the tax return ID of “SUT-US-07/2006-1” is selected. Once selected, the details of the selected tax return item may be displayed at step 222. In some instances, the details may populate a detail area 375 located below the set of tax return items. In other implementations, instead of displaying the selected tax return item details in the detail area 375, the tax return item details may be presented in a new window that opens separately from the tax monitor interface 300. As illustrated in FIGS. 3A-3C, the detail area 375 includes three sets of detail data available to the user: the General Data tab 380, the Payment Information tab 385, and the Notes tab 390. While interacting with the tax return view 305, the user may activate the tabs to show different sets of additional details regarding the selected tax return item. FIG. 3A shows the detail area 375 set to display the General Data tab 380, while FIGS. 3B and 3C illustrate the detail area 375 set to display the Payment Information tab 385 and the Notes tab 390, respectively.

Referring first to FIG. 3A, the General Data tab 380 may provide a set of general information associated with the selected tax return item, including the tax declaring company, the origin location or country of the declaring company, the declaring company's tax registration ID, the tax authority or region in which the declaring company is located, the tax return item's due date, and submission information related to the selected item. In other instances, the information displayed by the General Data tab 380 may differ, including more or less information about the selected tax return item.

FIG. 3B illustrates the tax monitor interface 300 where the user has activated the Payment Information tab 385 in the detail area 375. In the current example, information on the remittance status, ID, and date are shown. Additionally, a listing of some or all transactions related to the selected tax return item is shown. In other instances, some fields within the Payment Information tab 385 may include embedded links to the associated tax payment view associated with the particular payment. Thus, by activating the link, the user may navigate to the tax payment view 505 for a particular transaction ID associated with the selected tax return item.

FIG. 3C illustrates the tax monitor interface 300 where the Note tab 390 has been activated. Miscellaneous information, such as commentary or notes on the selected tax return item, may be added by the user. In some instances, the Notes tab 390 may be populated by information retrieved from the one or more business objects 155 responsible for the selected tax return item. In other instances, the Notes tab 390 may be populated with automatically produced messages indicating when and/or how users have accessed or modified the information.

Returning to FIG. 2, at step 224, the tax monitor module 140 may allow the user to open the selected tax return item in order to display the original tax return document. In effect, the user may view the information entered into the original tax return in order to review or audit the tax information creating the selected tax return item. FIGS. 3A-3C illustrate an Open Tax Return UI element 320 that may be activated while one of the second-level elements is selected. For instance, while the second level element 370 is selected, the UI element 320 may be activated to present the original tax return. Activating the UI element 320 may cause the tax monitor module 140 to retrieve the original tax return from the one or more business objects 155. In some instances, the user may be able to modify one or more fields or entries within or associated with the original tax return. In addition to opening the selected tax return item, the tax monitor module 140 may provide the user with the ability to execute various other actions such as printing the tax return item or displaying the tax return item's output.

In other implementations, at step 226, the process 200 may allow the user to cancel the selected tax return where the tax return has a declaration status of “proposed” or the equivalent thereof. Once an item is selected, the user may activate the Actions UI element 323 of FIG. 3A such that a dropdown list of actions is presented. Listed among those options may be a “Cancel” action. By activating (e.g., mouse-clicking) the option, the tax return item may be cancelled. In some instances, the information associated with the tax return item may be retained in its normal location, while in other instances, the information associated with the cancelled tax return item may be permanently deleted. If the information is retained, a message or notification regarding the cancellation may be sent to the one or more business objects 155 responsible for the tax return item. Opening or canceling a tax return item may be done at any time throughout process 200, and is not restricted to the order illustrated in FIG. 2.

At step 228, the process 200 determines whether the tax monitor module 140 has received a command from the user to display one of the other views. If such a command has been received, then process 200 receives the user selection at step 210. In the tax monitor interface 300, UI element 310 provides the user the ability to quickly navigate between views. In the current example, radio buttons are used to indicate the present view, as well as the option to navigate to the other available views. In other examples, different types of navigational tools may be used. If a command has not been received, process 200 moves to step 230 where a second tax return item is selected. Upon selection of the second tax return item, the process 200 displays the details for the selected tax return item at step 222. The process 200 continues for the tax return view 305 until a command to change views is received at step 228.

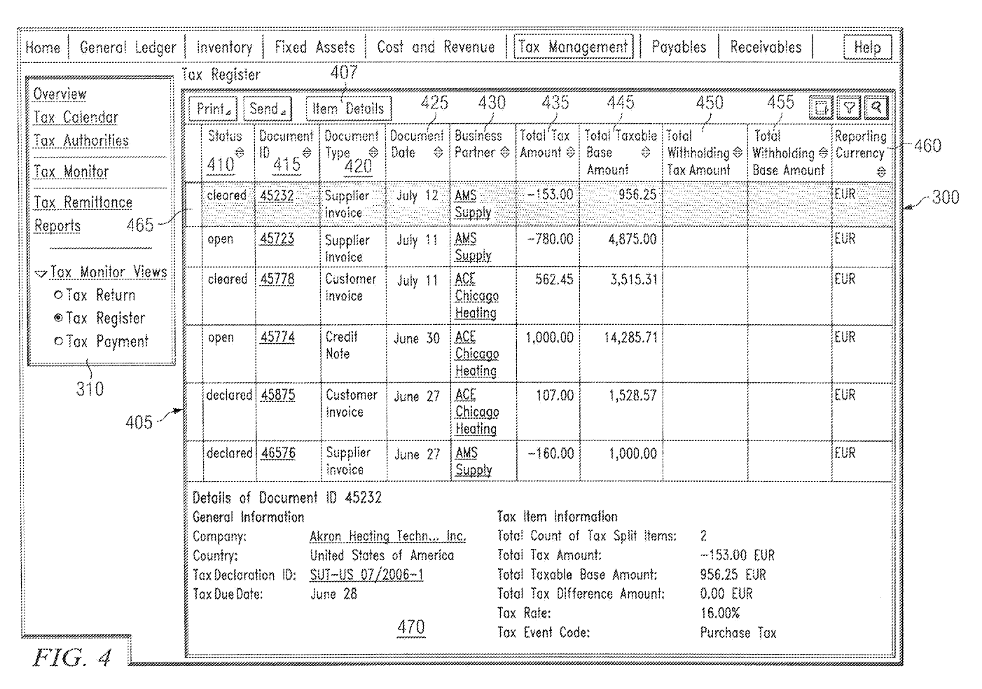

When the user view selection at step 210 determines that the tax register view 405 (illustrated in FIG. 4) is to be displayed, the tax monitor module 140 displays a portion of the tax information related to one or more tax register items associated with one or more of the user's authorized entities at step 234. The tax register view 405 permits the user to review a plurality of tax items, including tax payables/receivables and their processing status, tax declaration items, and tax payment items. In the illustrated example of FIG. 4, the tax register view 405 presents the following fields: status field 410, document ID field 415, document type field 420, document date field 425, business partner field 430, total tax amount field 435, total taxable base amount field 445, total withholding tax amount 450, total withholding base amount field 455, and reporting currency field 460. In some instances, the set of information and fields presented in the tax register view 405 may include, but are not limited to, the following: business partner, business partner tax ID, tax event type code, tax event type code description, tax rate code, tax amount (in declaration currency), tax amount (in transaction currency), withholding tax (in declaration currency), withholding tax (in transaction currency), gross amount (in declaration currency), gross amount (in transaction currency), difference tax amount, cash discount amount, transaction type, transaction document reference, tax due date, tax region code, tax country code, tax jurisdiction code, clearing reference, replacement status code, accounting transaction date, company, deductible input VAT, non-deductible input VAT, tax due category code, or system administrative data.

In the tax register view 405, the tax register items may be displayed in a predetermined order, for example, by the date associated with the particular tax register item. In some instances, the set of tax register items may display tax item amounts in both the declaration currency and the transaction currency. After initially displaying the tax register items, the tax monitor interface 300 may allow sorting and/or grouping of the tax register items according to one or more set of criteria associated with the items. In the illustrated example of FIG. 4, users may sort the tax register view 405 by one or more of the fields presented.

Returning to FIG. 2, once the set of tax register items is displayed, process 200 allows the user to select a particular tax register item at step 238. In some instances, the selection of a first tax register item may be made automatically upon the initial loading of the tax register view 405, while in other instances the selection may be made in response to a user action indicating the particular tax register item, such as a mouse-click or keyboard entry. In the example shown in FIG. 4, tax register item 465 is initially selected. In instances where the selected tax register item 465 is related to the representative of a tax group, data for one or more of the entities making up the tax group may be selected according to the entity tax arrangement. Upon selection of the item 465, a details field 470 may provide an additional set of information related to the tax register item. In some implementations, the user may modify the settings of the tax monitor module 140 to determine which details are to be displayed in the details field 470 upon item selection. Additionally, should more details be desired, an Item Details UI element 407 may be provided in the tax register view 405. By activating (e.g., double-clicking) the Item Details UI element 407, further details may be provided to the user. In some instances, the additional details may be provided in the details field 470 along with the previously presented details. In other instances, a new window or interface may open upon activation of the UI element 407 to present the additional details.

At step 242, the process 200 may determine whether the selected tax register item is a declared or non-declared item. In some instances, the tax monitor module 140 may provide the user with information on the tax declaration status of the selected tax register item upon selection, such as the status field 410 of FIG. 4. If the selected tax register item is declared, the process 200 continues to step 246. However, if the selected tax register item is non-declared, such as those having a tax declaration status of “open,” the user may review and, if necessary, modify the selected item at step 258. In those instances, the previously described Item Details UI element 407 may be used to review the tax register item's information. The user may be able to modify the details and information associated with the item in the details field 470 and/or the new window presenting the additional details.

In addition to modifying the tax register item, at step 262 the user may request or perform an internal audit of the selected tax register item prior to creating the tax register item's tax declaration. During the internal audit, the user may review the details and documents related to the tax register item. At step 266, the process 200 determines whether the user has indicated that the tax register item contains an error or some data requiring additional review. If errors have not been identified, then the process 200 may return to step 246. If errors have been identified, at step 270 the tax monitor module 140 may notify the application, business object 155, or other sub-module responsible for the creation and maintenance of the selected tax register item of the issue, including the need to review and/or rectify the identified problem. In some instances, the tax monitor module 140 may provide the user with the capabilities to define a task or action for the associated application, business object 155, or sub-module to perform in order to correct the issue. In addition to the notice sent by the tax monitor module 140, the communication may include a request for clarification of a portion of the included information, as well as the basis for certain calculations within the selected tax register item. In other instances, the tax monitor module 140 may provide additional auditing tools to provide a centralized location for auditing the tax register.

After sending the notification and any related tasks, the process 200 waits at step 274 to receive any corrections, clarifications, and/or updates to the selected tax register item. In some instances, the process 200 may continue to operate while waiting for the updated information on the selected tax register item. In certain implementations, once the application, business object 155, or sub-module completes the update, a message may be delivered to the user at the GUI 110, indicating that a refresh of the tax monitor interface 300 may be necessary. Once the corrections and updates are received, the process 200 continues to step 246.

At step 246, the process 200 may display the original documents related to the selected tax register item. For instance, if the original document in the tax register is a customer invoice, the tax monitor module 140 may retrieve the invoice and display it in a new window. In other instances, the tax monitor interface 300 may navigate away from the tax register view 405 and display the original document. Regardless of how the original document is displayed, this functionality provides users with the ability to review the documents on which the tax register items are based. In some instances, the original documents may be available through the activation of a hyperlink embedded in the tax monitor interface 300. At step 250, the process 200 may also display the clearing documents associated with the tax register item. Similar to displaying the original documents, the clearing documents may be displayed in a new window, or instead, in place of the tax register view 405 on the tax monitor interface 300.

At step 252, the process 200 determines whether the tax monitor module 140 has received a command from the user to display one of the other views (e.g., user activation of the UI element 310). If a command has been received, then process 200 returns to step 210 where the user selection is received. If a command has not been received, the process 200 continues to step 254 where a new tax register item is selected. Upon selection of the new tax register item, the process 200 continues at step 242.

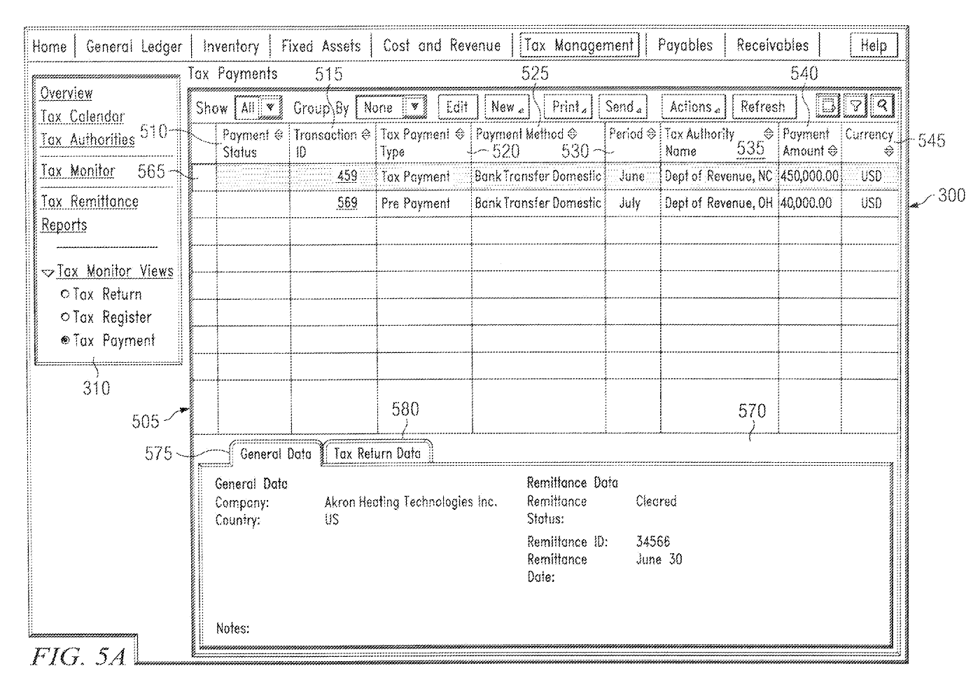

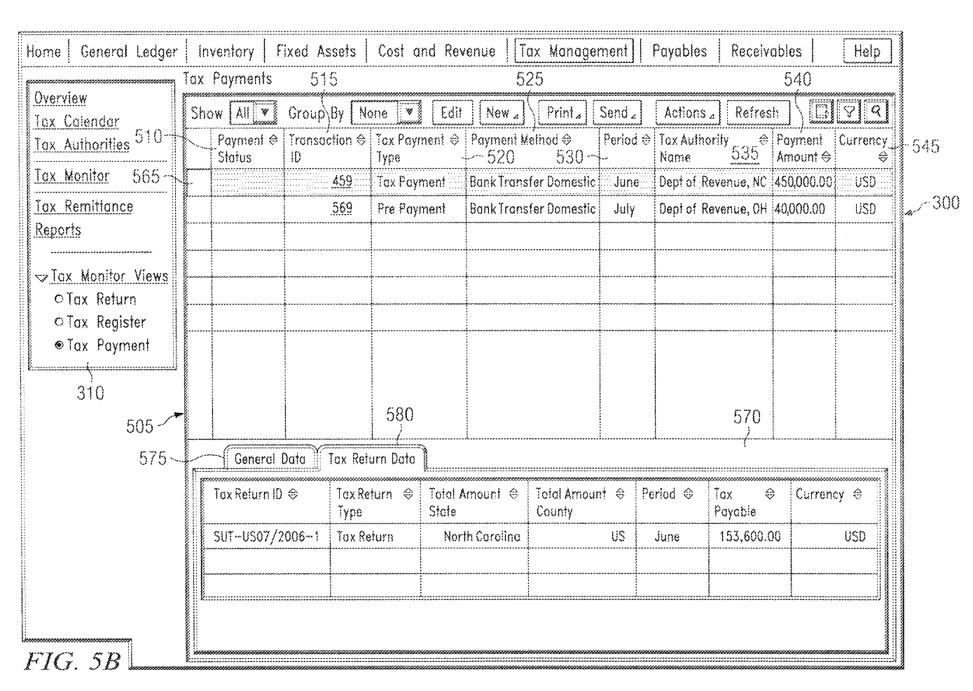

When the user view selection indicates that the tax payments view 505 is to be displayed, the tax monitor module 140 displays at least a portion of the tax information related to one or more tax payment items at step 278, where the one or more tax payment items are associated with at least one of the user's authorized entities. The tax payment view 505 permits the user to review data relating to the tax payments made by each entity. In some instances, the initial display of the tax payment view may be presented in a predetermined order (e.g., sorted by date, transaction ID, etc.). The items may also be initially sorted according to the other fields displayed in the tax payment view 505, including the payment status field 510, transaction ID field 515, tax payment type field 520, payment method field 525, period field 530, tax authority name field 535, payment amount field 540, or currency field 545. In some instances, the set of information and fields presented in the tax payment view 405 may include, but are not limited to, the following: tax payment status, tax payment total amount, tax payment date, tax authority, tax authority country code, tax payment type, tax declaration status, tax declaration period, company, tax declaration ID, tax declaration total amount (in declaration currency), tax declaration total amount (in transaction currency), carry forward amount, or system administrative data. The tax payment items may also be sorted based upon fields other than those shown in FIGS. 5A-5B. Regardless of the initial display, the user may interact with the tax payments view 505 to sort or group the items by any of the available fields. In some instances, the tax payment items may be grouped by clearing references. In those instances, the clearing reference may be used as a link between related tax payment items and tax return and/or register items. Additionally, the tax payment view 505 may provide a listing of the tax returns and declarations associated with each tax payment item.

At step 279, one of the tax payment items may be selected by the user. In example FIGS. 5A-5B, tax payment item 565 is selected. Once selected, details regarding the selected tax payment item 565 may be displayed in details field 570 at step 280. Similar to the details field 375 of FIGS. 3A-3B, the detail area 570 may be located below the set of tax payment items. In other implementations, the tax payment details may be provided in a new window that opens apart from the tax monitor interface 300 in a new window. As illustrated in FIGS. 5A-5B, the detail area 570 includes two tabs: the General Data tab 575 and the Tax Return Data tab 580. Other implementations may include different sets of tabs than illustrated in FIGS. 5A-5B. Through interaction with the tabs, the user may review different sets of details associated with the selected tax payment item 565.

Referring first to FIG. 5A, the General Data tab 575 provides basic information about the selected tax payment item 565, such as the company responsible for the tax payment, as well as that company's country affiliation. Additionally, information regarding the company's remittance, such as the remittance status, ID, and date, may be included. FIG. 5B illustrates the tax payment view 505 where the user has activated the Tax Return Data tab 580 in the detail area 570. The Tax Return Data tab 580 provides a listing of the tax return items associated with the selected tax payment item 565. In the current instance, the tax return item with the tax return ID of “SUT-US-07/2006-1” is associated with the selected tax payment item 565. A set of details associated with the related tax return item may be included in the tab 580. In some instances, more than one tax return may be related to the selected tax payment item. Additionally, the related tax return items may include links to the associated tax return view 305 associated with each tax return item. By activating the link, the user may navigate the tax monitor interface 300 to the tax return item view 305 for the particular related tax return item.

Returning to FIG. 2, at step 282 the tax monitor module 140 may receive user-defined layouts reflecting the initial display preferred by the user. Then, at step 286, the tax monitor module 140 may display the tax payment items according to the user-defined layout. The process 200 may allow users to choose particular fields or sequences of fields to be displayed and to specify a particular grouping of tax payment items, as well as sort, filter, and perform summing functions on the data.

At step 290, the tax monitor module 140 may receive a user request for a report based on archived periods of tax payments. Upon receiving the user request, the tax monitor module 140 may prepare the requested report. For instance, tax payments for a particular time period may be collected and presented in report format for delivery to the user. This may be advantageous for users authorized to review the tax information of more than one taxed entity, in that the amount of information would be difficult to accurately review in the normal layout. In some instances, all data associated with a tax payment item may be available for inclusion in the report.

At step 292, the process 200 determines whether the tax monitor module 140 has received a command from the user to display one of the other views. If a command to display another view has been received, then process 200 returns to step 210. If a command to display another view has not been received, then process 200 returns to step 278 wherein the tax payment items are displayed.

While the present disclosure uses a flowchart and accompanying descriptions to illustrate the example techniques embodied in process 200, environment 100 contemplates using or implementing any suitable technique for performing these and other tasks. It will be understood that these techniques are for illustration purposes only and that the described or similar techniques may be performed at any appropriate time, including concurrently, individually, or in combination. In addition, many of the steps in these flowcharts may take place simultaneously and/or in different orders than as shown. Moreover, environment 100 may use methods with additional steps, fewer steps, and/or different steps, so long as the method remains appropriate.

Although this disclosure has been described in terms of certain implementations and generally associated methods, alterations and permutations of these implementations and methods will be apparent to those skilled in the art. For instance, the tax monitor module 140 may be able to create projections of future tax liabilities for users based upon one or more entities' previous trends and actions. Additionally, the tax monitor module 140 may include functionality for generating graphs that chart the tax information such that the graphs may be presented to the user at the tax monitor interface 300. Accordingly, the above description of example implementations does not define or constrain the disclosure. Other changes, substitutions, and alterations are also possible without departing from the spirit and scope of this disclosure, and such changes, substitutions, and alterations may be included within the scope of the claims included herewith.

What is claimed is:

1. Software for monitoring tax information in a business application comprising computer readable instructions embedded on media and operable when executed to:
collect a set of tax information associated with at least one taxed entity from a plurality of logically disparate sub-modules, each sub-module associated with a business application; and
present at least a portion of the collected set of tax information at a centralized reporting interface to a first client authorized by the particular taxed entity, wherein presenting at least a portion of the set of tax information comprises displaying one or more of the following:
tax information related to one or more tax returns associated with the particular taxed entity;
tax information related to one or more tax registers associated with the particular taxed entity; or
tax information related to one or more tax payments associated with the particular taxed entity.

2. The software of claim 1, wherein the plurality of sub-modules comprise a plurality of business objects.

3. The software of claim 1, wherein each of at least a subset of sub-modules is associated with a different business application.

4. The software of claim 1 further operable to identify an original document associated with a particular subset of the tax information associated with the particular taxed entity.

5. The software of claim 4 further operable to modify the original document associated with the particular taxed entity.

6. The software of claim 5, wherein the particular set of tax information is one of a particular tax return, tax register, or tax payment.

7. The software of claim 1, wherein presenting at least a portion of the set of tax information comprises presenting the at least a portion of the collected set of tax information in a hierarchical order.

8. The software of claim 1, wherein the at least a portion of the collected set of tax information presented at the centralized reporting interface is sorted according to one or more criteria associated with the at least a portion of the collected set of tax information.

9. The software of claim 1, wherein the tax information related to one or more tax returns associated with the particular taxed entity comprises links to the one or more tax payments associated with the particular taxed entity.

10. The software of claim 1 further operable to:
receive a first set of credentials, the first set of credentials associated with a first user and one or more taxed entities;
verify the first set of credentials; and
provide access to a subset of the set of tax information, wherein the subset of the set of tax information comprises tax information associated with the one or more taxed entities.

11. The software of claim 1 further operable to:
create an error-correction task based, at least in part, upon an error identified by the first user, wherein the error-correction task comprises at least a portion of the set of tax information having at least one error and at least one correction to the set of tax information;
send the error-correction task to one or more sub-modules of the plurality of logically disparate sub-modules associated with the at least a portion of the set of tax information having the at least one error; and
receive confirmation from the one or more sub-modules of the plurality of logically disparate sub-modules that the error-correction task is performed.

12. The software of claim 1, wherein displaying the tax information related to one or more tax returns comprises displaying a substantial subset of the following:
a business partner of the taxed entity;
a tax identification number of the business partner;
a tax event type code;
a description of the tax event type code;
a tax rate code;
a tax amount;
a withholding tax amount;
a gross tax amount;
a difference tax amount;
a cash discount amount;
a transaction type;
a transaction document reference;
a tax due date;
a tax region code;
a tax country code;
a tax jurisdiction code;
a clearing reference;
a replacement status code;
an accounting transaction date;
a company associated with the one or more tax returns;
a deductible input VAT;
a non-deductible input VAT;
a tax due category code; and
a set of system administrative data.

13. A computer-implemented method for monitoring tax information in a business application, comprising:
collecting a set of tax information associated with at least one taxed entity from a plurality of logically disparate sub-modules, each sub-module associated with a business application; and
presenting at least a portion of the collected set of tax information at a centralized reporting interface to a first client authorized by the particular taxed entity, wherein presenting at least a portion of the set of tax information comprises displaying one or more of the following:
tax information related to one or more tax returns associated with the particular taxed entity;
tax information related to one or more tax registers associated with the particular taxed entity; or
tax information related to one or more tax payments associated with the particular taxed entity.

14. The method of claim 13, wherein the plurality of sub-modules comprise a plurality of business objects.

15. The method of claim 13, wherein each of at least a subset of sub-modules is associated with a different business application.

16. The method of claim 13 further comprising identifying an original document associated with a particular subset of the tax information associated with the particular taxed entity.

17. The method of claim 16 further comprising modifying the original document.

18. The method of claim 17, wherein the particular set of tax information is one of a particular tax return, tax register, or tax payment.

19. The method of claim 13, wherein presenting at least a portion of the set of tax information comprises presenting the at least a portion of the collected set of tax information in a hierarchical order.

20. The method of claim 13, wherein the at least a portion of the collected set of tax information presented at the centralized reporting interface is sorted according to one or more criteria associated with the at least a portion of the collected set of tax information.

21. The method of claim 13, wherein the tax information related to one or more tax returns associated with the particular taxed entity comprises links to the one or more tax payments associated with the particular taxed entity.

22. The method of claim 13 further comprising:
receiving a first set of credentials, the first set of credentials associated with a first user and one or more taxed entities;
verifying the first set of credentials; and
providing access to a subset of the set of tax information, wherein the subset of the set of tax information comprises tax information associated with the one or more taxed entities.

23. The method of claim 13, wherein displaying the tax information related to one or more tax returns comprises displaying a substantial subset of the following:
a business partner of the taxed entity;
a tax identification number of the business partner;
a tax event type code;
a description of the tax event type code;
a tax rate code;
a tax amount;
a withholding tax amount;
a gross tax amount;
a difference tax amount;
a cash discount amount;
a transaction type;
a transaction document reference;
a tax due date;
a tax region code;
a tax country code;
a tax jurisdiction code;
a clearing reference;
a replacement status code;
an accounting transaction date;
a company associated with the one or more tax returns;
a deductible input VAT;
a non-deductible input VAT;
a tax due category code; and
a set of system administrative data.
